(19) United States
(12) Patent Application Publication
(10) Pub. No.: US 2019/0091723 A1
(43) Pub. Date: Mar. 28, 2019

(54) MASKING METHOD WITH INKJET INK, AND COLORING SYSTEM

(71) Applicant: MIMAKI ENGINEERING CO., LTD., Nagano (JP)

(72) Inventors: NORIKAZU NAKAMURA, NAGANO (JP); ISAO TABAYASHI, NAGANO (JP); MASARU OHNISHI, NAGANO (JP)

(73) Assignee: MIMAKI ENGINEERING CO., LTD., Nagano (JP)

(21) Appl. No.: 16/199,242

(22) Filed: Nov. 26, 2018

Related U.S. Application Data
(63) Continuation of application No. 14/280,700, filed on May 19, 2014.

(30) Foreign Application Priority Data
May 27, 2013 (JP) 2013-110572

(51) Int. Cl. B05D 5/00; B05D 1/32; B05D 1/02; B05D 5/06

(52) U.S. Cl. CPC B05D 5/00; B05D 1/322; B05D 5/06; B05D 2202/25; B05D 1/02

(57) ABSTRACT

A method for masking with an inkjet ink, which is applied to a step of coloring a coloring substrate with a dye solution containing a dye in a solvent, is provided. The coloring substrate is colored by permeation of the dye solution. The method includes: a coloring mask forming step of forming a coloring mask which covers a region that is not colored on a surface of the coloring substrate; a dye coloring step of coloring the coloring substrate with the dye solution in a region not covered by the coloring mask; and a mask detaching step of detaching the coloring mask from the coloring substrate after the dye coloring step. In the coloring mask forming step, a mask forming liquid as a liquid for forming the coloring mask is ejected onto the coloring substrate with a liquid ejection head that ejects liquid using an inkjet scheme.

### CROSS REFERENCE TO RELATED APPLICATIONS

The present application is a continuation application of U.S. application Ser. No. 14/280,700 filed on May 19, 2014, now pending. The prior U.S. application Ser. No. 14/280,700 claims the priority benefit of Japanese application serial no. 2013-110572, filed on May 27, 2013. The entirety of the above-mentioned patent application is hereby incorporated by reference herein and made a part of this specification.

### TECHNICAL FIELD

The present invention relates to a masking method with inkjet ink and a coloring system.

### DESCRIPTION OF THE BACKGROUND ART

Aluminum materials such as aluminum subjected to an anodizing process (alumite process) have been widely used. For example, a method is known that colors such aluminum materials. In this method, an aluminum material with an anodized coating is subjected to an etching process in a dilute alkaline aqueous solution, so as to chemically dissolve the surface of the exposed portion of a barrier layer at the bottom portion in the pores of the anodized coating. The aluminum material is then colored either electrolytically in a metal salt-containing electrolytic coloring bath, or by being dipped in a pigment dispersion to allow pigment particles to electrophoretically migrate and deposit inside the pores of the anodized coating (see, for example, Patent Literature 1, JP-A-11-236697).

### CITATION LIST

### Patent Document

Patent Literature 1: JP-A-11-236697

In the method disclosed in Patent Literature 1, colors are provided electrolytically, or by electrophoretic migration and deposition of pigment particles. However, there are increasing demands for more appropriate coloring methods (for example, a faster coloring method, and a low-cost coloring method), for example, in manufacture of industrial products. It is accordingly an object of the present invention to provide a colored aluminum article producing method, a coloring method, and a liquid ejection apparatus intended to solve the foregoing problem.

### SUMMARY

After intensive studies, the inventors of the present application found an efficient way to appropriately color a coloring substrate with a dye solution, using a coloring mask formed with a liquid ejection head that ejects liquid using the inkjet scheme. The present invention includes the following configurations to solve the foregoing problem.

(Configuration 1) A method for masking with an inkjet ink, which is applied to a step of coloring a coloring substrate with a dye solution containing a dye in a solvent, wherein the coloring substrate is colored by permeation of the dye solution. The method includes: a coloring mask forming step of forming a coloring mask which covers a region that is not colored on a surface of the coloring substrate; a dye coloring step of coloring the coloring substrate with the dye solution in a region not covered by the coloring mask; and a mask detaching step of detaching the coloring mask from the coloring substrate after the dye coloring step. In the coloring mask forming step, a mask forming liquid as a liquid for forming the coloring mask is ejected onto the coloring substrate with a liquid ejection head that ejects liquid using an inkjet scheme.

(Configuration 2) According to an embodiment of the disclosure, the mask forming liquid is a UV curable ink

(Configuration 3) According to an embodiment of the disclosure, the mask forming liquid is a UV curable ink having a stretch property after being cured.

(Configuration 4) According to an embodiment of the disclosure, the coloring mask forming step includes: a rim forming step of forming a rim of the coloring mask with a first mask forming liquid for which a UV curable ink is used; and an inner region forming step of forming a mask inner region surrounded by the rim of the coloring mask, using a second mask forming liquid for which an ink is used that requires evaporation of solvent for fixing itself to the coloring substrate, wherein, in the rim forming step, a first liquid ejection head for ejecting the first mask forming liquid is used to eject the first mask forming liquid to a region that becomes the rim of the coloring mask, and the first mask forming liquid landed on the coloring substrate is irradiated with ultraviolet light to form the rim of the coloring mask, and wherein, in the inner region forming step, a second liquid ejection head for ejecting the second mask forming liquid is used to eject the second mask forming liquid to the region surrounded by the rim formed in the rim forming step, and form the mask inner region of the coloring mask.

(Configuration 5) A coloring system is further provided and includes: a dye solution, containing a dye in a solvent; a coloring substrate, being colored by permeation of the dye solution; and a liquid ejection apparatus, being configured to form a coloring mask that covers a pre-defined region of the coloring substrate. The liquid ejection apparatus includes: a liquid ejection head with which a mask forming liquid as a liquid for forming the coloring mask is ejected using an inkjet scheme; and a controller, being configured to control the liquid ejection head so as to eject the mask forming liquid to a region of the coloring mask. The same effects obtained in, for example, configuration 1 also can be obtained with this configuration.

The present invention can appropriately color an aluminum material, for example.

### BRIEF DESCRIPTION OF THE DRAWINGS

FIG. 1 is a flowchart representing an example of a colored aluminum article producing method according to an embodiment of the present invention.

FIGS. 2A˜2C are diagrams explaining an example of a coloring mask, in which FIG. 2A is an exemplary configuration of a liquid ejection apparatus 10 used to form the coloring mask, FIG. 2B is an exemplary configuration of a coloring mask 102 formed on an aluminum material 20, and FIG. 2C is an exemplary configuration of the aluminum material 20 after being colored.

FIGS. 3A˜3C are diagrams representing a first variation of coloring mask 102 formation, in which FIGS. 3A, 3B, and 3C are examples of the steps of forming the coloring mask 102 in this variation.

FIGS. 4A˜4B are diagrams representing a second variation of coloring mask 102 formation, in which FIGS. 4A and 4B are examples of the steps of forming the coloring mask 102 in this variation.

FIGS. 5A˜5B are diagrams representing exemplary methods of coloring the aluminum material 20 in full-color, in which FIG. 5A is a first example of coloring the aluminum material 20 in full-color, and FIG. 5B is a second example of coloring the aluminum material 20 in full-color.

### DESCRIPTION OF EXEMPLARY EMBODIMENTS

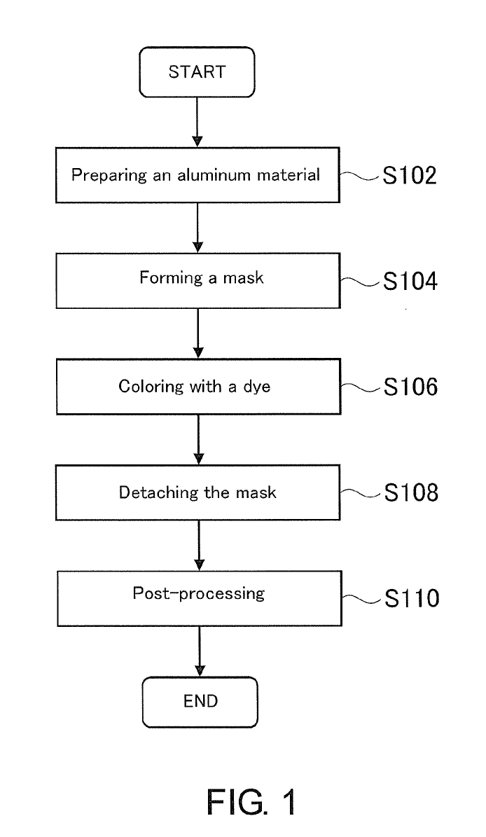

Embodiments according to the present invention are described below with reference to the accompanying drawings. FIG. 1 is a flowchart of an example of a colored aluminum article producing method according to an embodiment of the present invention, representing exemplary steps of producing a colored aluminum article through dyeing of an aluminum material. The aluminum material is, for example, an aluminum member with an anodized coating formed in at least a region where a color is to be provided. The aluminum material may be aluminum (aluminum metal, or aluminum alloy) subjected to an anodizing process (alumite process). In this example, the colored aluminum article producing method includes at least a preparation step S102, a mask forming step S104, a coloring step S106, a mask detaching step S108, and a post-processing step S110. These steps may be the same or similar steps conventionally used for coloring aluminum materials, excepting for the following description.

The preparation step S102 is a step of preparing an aluminum material to be colored. For example, an aluminum metal or aluminum alloy member is subjected to an anodizing process (alumite process) to prepare an aluminum material that has an anodized coating on the surface. Specifically, in the preparation step S102, an aluminum metal or aluminum alloy member is subjected to a series of processes that includes, for example, degreasing, water washing, etching, water washing, neutralization, electrolysis, and water washing to prepare an aluminum material for coloring. The etching is the process that dissolves the surface of the exposed portion of a barrier layer at the bottom portion in the pores of the anodized coating of the aluminum material, and is performed by, for example, an oxidation treatment that uses an acidic liquid such as sulfuric acid.

The mask forming step S104 is a step of forming a coloring mask that covers a region of the aluminum material where a color is not to be provided. In this example, the mask forming step S104 forms the coloring mask with the use of a liquid ejection apparatus that ejects a mask forming liquid as a liquid for forming the coloring mask. The liquid ejection apparatus is, for example, an apparatus that ejects liquid through a liquid ejection head using the inkjet head system. The coloring mask is an example of a defined region coating mask that covers a pre-defined region of the aluminum material. Formation of the coloring mask will be described later in greater detail.

The coloring step S106 is a step of dyeing the aluminum material in the region not covered by the coloring mask. In the coloring step S106, for example, the aluminum material with the coloring mask is dipped in a dye ink to color the aluminum material. The dye ink is a dye solution that uses a solvent capable of dissolving the dye, or that uses water as a solvent (dye dissolvable solvent). In this way, for example, the aluminum material can be appropriately colored in the region not covered by the coloring mask.

In the coloring step S106, for example, by placing the aluminum material in a container which is filled with the dye ink, thus the aluminum material is dipped in the dye ink. Various solvents, including organic solvents or water may be used as the dye dissolvable solvent, provided that colors can be appropriately provided. In the coloring step S106, it may be possible to dip the aluminum material in the dye ink, for example, by ejecting the dye ink to the aluminum material through a liquid ejection head. In this case, for example, the dye ink can be selectively ejected to locations requiring colors, and colors can be efficiently provided with less dye ink.

The mask detaching step S108 is a step of detaching the coloring mask from the aluminum material after the coloring step S106. In the mask detaching step S108, for example, the coloring mask is detached from the aluminum material with a remover such as IPA (isopropyl alcohol). The mask detaching step S108 may be performed, for example, by dipping the aluminum material in a remover for about 20 minutes.

The post-processing step S110 is a step of conditioning the surface state of the colored aluminum material. The post-processing step S110 performs a series of processes that includes, for example, pore sealing, water washing, and drying to condition the surface state of the aluminum material. The pore sealing is the process in which the fine pores of the alumite coating are sealed by heating with, for example, hot water and steam. After the pore sealing process, the dye can appropriately be fixed to the aluminum material. The subsequent washing and drying processes can appropriately clean the surface of the aluminum material.

According to the present example, for example, the liquid ejection head of the liquid ejection apparatus is used to form the coloring mask, and the coloring mask can be appropriately formed in a short time period and at low cost. Further, by using a dye, the aluminum material can be colored both easily and appropriately. The present example can thus appropriately color, for example, an aluminum material in a short time period and at low cost.

For convenience of explanation, descriptions have been given through the case where a single-color dye ink is used. It is also possible to use, for example, dye inks of more than one color when more than one color is to be provided. In this case, for example, the procedures of the mask forming step S104 to the mask detaching step S108 may be repeated a plurality of times to color the aluminum material with the dye ink of each color. In this way, more than one color can be appropriately provided. It is also considered possible to provide a partial decoration, for example, by performing the foregoing coloring procedures for an aluminum material that has a base color. It would also be possible to provide a full-color image by repeating the procedures of the mask forming step S104 to the mask detaching step S108 four times with dye inks of YMCK.

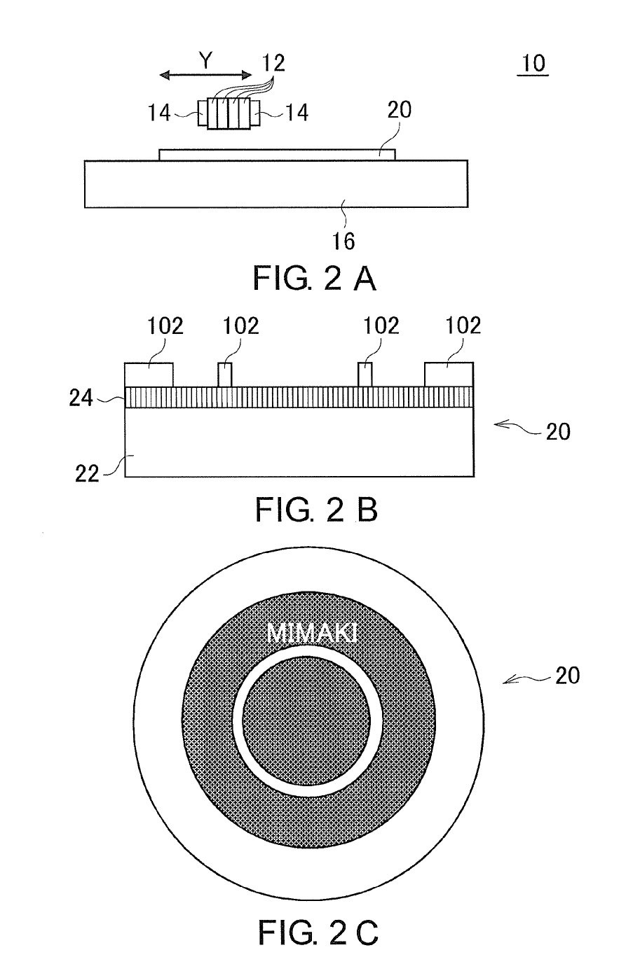

The mask forming step S104 to the mask detaching step S108 are described below in greater detail. FIGS. 2A˜2C are diagrams explaining an example of the coloring mask, in which FIG. 2A represents the configuration of a liquid ejection apparatus 10 used to form the coloring mask. In this example, the liquid ejection apparatus 10 includes a plurality of liquid ejection heads 12, ultraviolet sources 14, and a table 16.

The liquid ejection apparatus 10, for example, may have the same or similar configuration used by an inkjet printer. For example, a known inkjet printer may be used as the liquid ejection apparatus 10. Further, for example, the liquid ejection apparatus 10 may include components having the same configurations as those of a known inkjet printer.

The liquid ejection heads 12 represent a head unit that ejects liquid using the inkjet system. As an example, known inkjet heads may preferably be used as the liquid ejection heads 12. In the mask forming step S104 (see FIG. 1), the mask forming liquid as a liquid for forming the coloring mask is ejected onto an aluminum material 20 through at least one of the liquid ejection heads 12. This forms the coloring mask on the aluminum material 20.

As an example of its operation, the liquid ejection heads 12 perform a main scan operation in which the liquid ejection head 12 ejects the liquid as it moves in the predetermined Y direction, and a sub scan operation in which the liquid ejection head 12 moves relative to the aluminum material 20 in X direction orthogonal to Y direction as does, for example, the inkjet head of a known inkjet printer. In this way, the liquid ejection heads 12 eject the mask forming liquid for each different location of the aluminum material 20. In the mask forming step S104, for example, the mask forming liquid may be ejected by using two or more liquid ejection heads 12.

The ultraviolet sources 14 are light sources that produce ultraviolet light for curing an UV curable ink. In this example, the ultraviolet sources 14 are provided at the both ends of the liquid ejection heads 12 relative to Y direction, and cure the mask forming liquid landed on the aluminum material 20 through irradiation of ultraviolet light. The table 16 is a board-like member for mounting the aluminum material 20. The aluminum material 20 is mounted on the top surface on the table 16, opposite the liquid ejection heads 12.

According to the present example, the mask forming liquid can be appropriately ejected to the desired locations of the aluminum material 20, and the mask forming liquid landed on the aluminum material 20 can be appropriately cured. This makes it possible to appropriately form the coloring mask of the desired shape on the aluminum material 20.

FIG. 2B represents an exemplary configuration of a coloring mask 102 formed on the aluminum material 20. In this example, the aluminum material 20 is configured to include an aluminum metal portion 22 existed as aluminum metal, and an alumite coating 24 formed on the surface of the aluminum metal portion 22. In the mask forming step S104, the coloring mask 102 is formed so as to cover regions in portions of the alumite coating 24. Accordingly, the aluminum material 20 contacts the dye ink only in surface portions not covered by the coloring mask 102 upon being dipped in the dye ink in the coloring step S106. The dye ink thus colors only the regions not covered by the coloring mask 102.

FIG. 2C is a diagram of an exemplary configuration of the aluminum material 20 after being colored, representing an exemplary state of the aluminum material 20 after the post-processing step S110 (see FIG. 1). As shown in the figure, the aluminum material 20 is dyed only in portions other than the regions covered by the coloring mask 102. The present example can thus appropriately color the desired regions of the aluminum material 20 according to the shape of the coloring mask 102 formed.

The mask forming liquid and the dyeing solution (dye ink) used in the present example are described below in greater detail. When the region not covered by the coloring mask 102 is to be colored with the dye solution as in this example, the coloring mask 102 is required not to permeate the dye underneath the coloring mask 102 (non-permeable to the colorant), not to dissolve in the dye solvent (solvent), and to be easily detachable after the coloring. The coloring dye is used in the form of a solution of dye molecules smaller than the size of pigment particles in the solvent. The dye thus has the risk of seeping into the region between the coloring mask 102 and the aluminum material 20, and undesirably color a part of the region covered with the coloring mask 102, for example, when the durability of the coloring mask 102 on the aluminum material 20 is insufficient, or when the adhesion between the coloring mask 102 and the aluminum material 20 is insufficient. It is believed that the durability and the adhesion of the coloring mask 102 depend on, for example, the material used for the coloring mask 102.

The dye used in the dye solution of this example may be a dye that is soluble in water, or a dye that is soluble in an organic solvent. Specific examples of the dye that is soluble in water include acidic dyes, reactive dyes, anionic dyes such as direct dyes, basic dyes, disperse dyes, mordant dyes, and vat dyes. The disperse dye is, for example, a dye that enters the pores and dyes the object of interest. The mordant dye is, for example, a dye that forms an insoluble metal complex salt through reaction with metal to dye an object of interest. The vat dye is, for example, a dye such as an indigo dye. Examples of the dye that is soluble in an organic solvent include spirit dyes, and oil-soluble dyes.

Particularly preferred for use in this example are dyes that have excellent lightfastness, specifically, for example, premetallized dyes. Particularly preferred as aqueous premetallized dyes are, for example, azo or phthalocyanine premetallized acidic dyes. Other possible examples of the dye that is soluble in an organic solvent include spirit dyes that are soluble in polar solvents such as alcohol or ketone, and oil-soluble premetallized dyes that are soluble in aromatic hydrocarbon, glycol ether solvent, and the like. The dye solution, particularly the aqueous dye solution preferably contains a water-soluble organic solvent or a surfactant to improve the wettability and the permeability of the dye solution for the porous oxidation coating layer formed on the aluminum material surface.

When these dye solutions are used, it is preferable to use, for example, an acrylic UV curable ink as the mask forming liquid. For example, an ink containing 50 weight % or more of an acrylic acid ester may be used as the acrylic UV curable ink. Here, “ink” means a liquid that can be ejected through, for example, the liquid ejection heads 12 using the inkjet system. The ink may be a transparent ink, for example, such as a clear ink, or may be a color ink such as a color printing ink.

A specific composition of the mask forming liquid (acrylic UV curable ink) is preferably selected according to the type of the dye solution used. For example, when an aqueous dye solution is used, it may not be possible to obtain sufficient masking effect when the acid number of the UV curable ink is 100 or more under alkaline pH. It is preferable in this case to use an acryl component that does not have an acidic group.

With such a mask forming liquid, the durability of the coloring mask 102 on the aluminum material 20, and the adhesion between the coloring mask 102 and the aluminum material 20 can be appropriately improved with, for example, the dye ink that uses a dye dissolvable solvent. It is also possible to appropriately satisfy the requirement for the coloring mask 102 not to permeate the dye underneath the mask. The requirements not to dissolve in the dye solvent (solvent), and to be easily detachable after the coloring also can be appropriately satisfied. The present example can thus appropriately form the coloring mask 102 satisfying the various conditions.

A UV curable ink of the property to stretch after curing is preferably used as the mask forming liquid. The UV curable ink of the property to stretch after the curing is, for example, a UV curable ink that turns itself into an elastic resin after being cured. With this configuration, for example, the adhesion between the coloring mask 102 and the aluminum material 20 can be more appropriately improved. It is also possible to more appropriately satisfy the requirement for the coloring mask 102 not to permeate the dye underneath the mask. Further, with the foregoing configuration, the coloring mask 102 can become more easily detachable after the coloring. The coloring mask 102 can thus be more appropriately formed with the foregoing configuration.

For example, when the UV curable ink of the property to stretch after the curing has an excessively high stretch rate, the excessive softness may increase solubility in certain types of dye solvent (solvent). It is therefore preferable that the UV curable ink of the property to stretch after the curing be, for example, an ink with a stretch rate of about 120% to 160%, more preferably an ink with a stretch rate of about 130% to 150%. The ink stretch rate of 120% to 160% (or 130% to 150%) means that the ink stretches, for example, at most 120% to 160% in terms of an area after being cured.

Preferred for use as the stretchable ink is, for example, a UV curable ink that contains 20 weight % to 30 weight % of a multifunctional monomer (for example, hexamethylene diacrylate), and 55 weight % to 65 weight % of a monofunctional monomer (for example, acrylic acid ester). Specific examples of the stretchable ink include the LF-140 UV curable ink available from Mimaki Engineering Co., Ltd. The LF-140 UV curable ink has a stretch rate of about 140%, and contains 55 weight % to 65 weight % of an acrylic acid ester, 20 weight % to 30 weight % of hexamethylene diacrylate, 10 weight % to 15 weight % of a polymerizable initiator, 0.1 weight % to 5 weight % of a pigment such as quinacridone magenta, and 0.1 weight % to 5 weight % of additives. With the LF-140 UV curable ink used as the mask forming liquid, the coloring mask 102 can be appropriately prevented from dissolving in the dye ink solvent, and a clear color image can be appropriately obtained with, for example, the dye ink that contains a dye dissolvable solvent. It is also possible to appropriately satisfy the requirements for the coloring mask 102 not to permeate the dye underneath the mask, and to be easily detachable when IPA is used as the remover.

The UV curable ink of the property to stretch after the curing may be an ink that has an even greater stretch rate, for example, such as the LF-200 UV curable ink available from Mimaki Engineering Co., Ltd. The LF-200 UV curable ink has a stretch rate of about 200%, and contains isobornyl acrylate, an amine modified acrylic acid oligomer, tetrahydrofurfuryl acrylate, an initiator (diphenyl-2,4,6-trimethylbenzoylphosphine oxide), 2-(2-ethoxyethoxy) ethyl acrylate, an acrylic acid ester, and additives (sensitizer, dispersant, and polymerization inhibitor). The coloring mask 102 also can be clearly formed also with such a mask forming liquid.

However, use of such a highly stretchable ink is potentially associated with increased solubility in the dye solvent because of the excessive ink softness, as noted above. For example, when the LF-200 UV curable ink is used, the alkali resistance of the cured coating may become insufficient, making the dye more permeable through the cured coating. It is therefore preferable to use an acidic solution, such as sulfuric acid, for the etching performed in the preparation step S102 of preparing the aluminum material 20 (see FIG. 1). In this case, for example, the pH of the coloring with the dye ink can be appropriately brought to a neutral pH range (for example, pH 6 to pH 8). This makes it possible to appropriately prevent the dye from passing through the coloring mask 102 even when the coloring mask 102 has a small alkali resistance.

When using the LF-200 UV curable ink, it is preferable to further heat the coloring mask 102 after the coloring mask 102 is cured by irradiation of ultraviolet light. In this way, for example, the hardness of the cured coating can be further improved. It is also possible to further increase the durability of the coloring mask 102. The heating effect can be obtained, for example, by several minutes of heating with a dryer. In order to more appropriately increase the hardness of the cured coating, it is preferable to apply heat with, for example, an oven at 50° C. to 60° C. for about 1 hour.

Under certain coloring conditions or purposes, an ink that undergoes essentially no stretch after the curing may be used as the mask forming liquid, instead of using the UV curable ink of the property to stretch after the curing. The ink that undergoes essentially no stretch after the curing is, for example, a common UV curable ink whose components are not adjusted to make the ink stretchable. Preferred for use as such an ink is, for example, a hard UV curable ink.

In this case, the dye has increased durability against the dye solvent or the like, for example, as compared to using the stretchable ink, and the durability of the coloring mask 102 can be appropriately and sufficiently increased, for example, even when the coloring mask 102 has a small thickness. The thinner thickness of the coloring mask 102 makes it possible to form, for example, finer patterns with high accuracy. In this way, for example, colors can be appropriately provided at higher resolutions.

The hard UV curable ink may be, for example, the LH-100 UV curable ink available from Mimaki Engineering Co., Ltd. The LH-100 UV curable ink contains 50% to 60% of an acrylic acid ester, 30 weight % to 35 weight % of hexamethylene diacrylate, 10 weight % to 15 weight % of an initiator (diphenyl-2,4,6-trimethylbenzoylphosphine oxide), and 0.1% to 5% of additives.

With the hard UV curable ink, the coloring mask 102 can be appropriately prevented from dissolving in the dye ink solvent, and the requirements for appropriately obtaining a clear color image, and the requirement for the coloring mask 102 not to permeate the dye underneath the mask can be appropriately satisfied. However, the detachability of the coloring mask 102 may suffer compared to using the stretchable ink. It is therefore preferable to dip the aluminum material 20 in a remover for a longer time period in the detaching step S106 when a hard UV curable ink is used as the mask forming liquid.

Other than the foregoing inks, for example, a UV curable primer ink may be used as the mask forming liquid. Specific examples of such an ink include the PR-100 UV curable ink available from Mimaki Engineering Co., Ltd. The PR-100 UV curable ink contains 80% to 90% of an acrylic acid ester, 10 weight % to 15 weight % of an initiator, and 0.1% to 5% of additives.

It should be noted, however, that using the PR-100 UV curable ink may lower the durability of the coloring mask 102 against the dye solvent or the like as compared to, for example, using the LF-140 or LH-100 UV curable ink. In this case, for example, the coloring mask 102 may dissolve in the dye solvent, and prevent a color from being appropriately provided.

When using the PR-100 UV curable ink, it is preferable to further heat the coloring mask 102 after the coloring mask 102 is cured by irradiation of ultraviolet light, as with the case of using the LF-200 UV curable ink described above. In this way, for example, the hardness of the cured coating can be further improved. This makes it possible to further increase the durability of the coloring mask 102.

The mask forming liquid may be, for example, an ink (liquid) other than the UV curable ink. Possible examples of such inks include solvent UV (SUV) inks prepared by adding a volatile organic solvent to a UV curable ink, and latex inks containing polymer materials such as an aqueous polymer. It is also considered possible to use inks containing resin capsules, or solid inks that are solid at ordinary temperature. The coloring mask of the desired shape also can be appropriately formed on the aluminum material 20 in this case by ejecting the ink on the aluminum material 20 with the liquid ejection heads 12. Solid inks (waxes: natural waxes such as carnauba wax, and beeswax; and synthetic waxes such as paraffin wax) also may be used as the mask material.

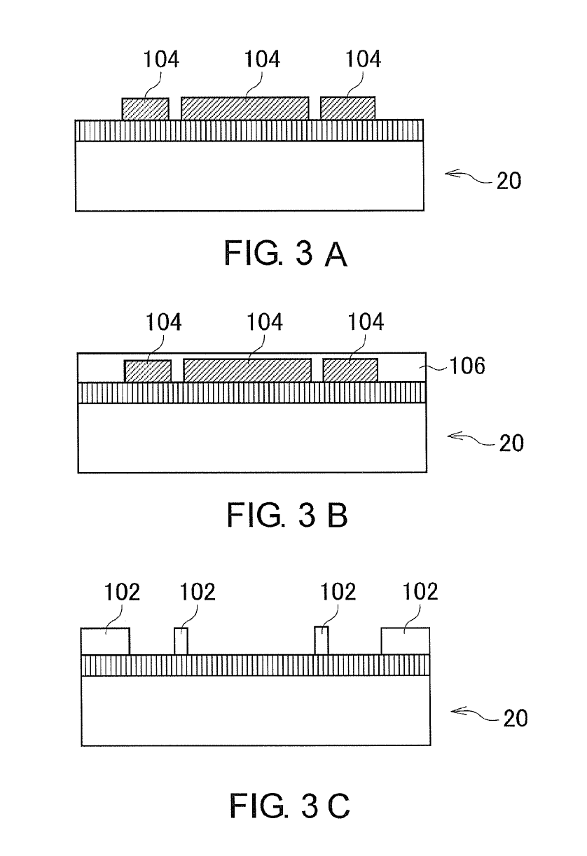

Variations of the coloring mask 102 formation in the mask forming step S104 are described below. FIGS. 3A˜3C represent a first variation of the coloring mask 102 formation, in which FIGS. 3A, 3B, and 3C are examples of the steps of forming the coloring mask 102 in this variation.

The formation of the coloring mask 102 of this variation is the same or similar to that described with reference to FIGS. 1 and 2A˜2C, excepting for the following description. The liquid ejection apparatus 10 used in this variation has the same or similar configuration to that shown in FIG. 2A.

In this variation, the mask forming liquid is used to form an intermediate mask 104, which is then used to form the coloring mask 102, instead of directly forming the coloring mask 102 with the mask forming liquid ejected through the liquid ejection heads 12 (see FIGS. 2A˜2C). The intermediate mask 104 is an example of the first mask that covers a region other than the pre-defined region.

Specifically, in the present variation, the mask forming liquid is ejected to regions other than the regions where the coloring mask 102 is to be formed, as shown in FIG. 3A, and the liquid forms the intermediate mask 104 covering these regions (mask forming step S104). The regions other than the regions where the coloring mask 102 is to be formed are, for example, target coloring regions of the aluminum material 20 where a color is to be provided.

After forming the intermediate mask 104, a material liquid of the coloring mask 102 is applied to the aluminum material 20 to form a coloring mask material layer 106, as shown in FIG. 3B. The material liquid of the coloring mask 102 may be applied, for example, by using a method other than the inkjet system. For example, the material liquid of the coloring mask 102 may be applied by spray coating. It is also possible to apply the material liquid of the coloring mask 102 using the inkjet system, using a liquid ejection head 12 different from that used to form the intermediate mask 104.

Thereafter, as shown in FIG. 3C, the intermediate mask 104 is removed, leaving the coloring mask 102 material, and forming the coloring mask 102 of the predetermined pattern only in the regions where it is needed. In this configuration, the coloring mask 102 may be formed by using a method other than the inkjet system. The material of the coloring mask 102 thus may be any of various liquids other than liquids that are ejectable using the inkjet system. The material of the coloring mask 102 can thus be freely selected from a wide range of materials, for example, such as materials with strong resistance to the dye solution.

The intermediate mask 104 formed by the mask forming liquid is used specifically in the process of forming the coloring mask 102. Accordingly, the intermediate mask 104 is not required to have durability or other resisting properties against the dye ink solvent. The foregoing configuration thus enables use of various liquids also for, for example, the mask forming liquid ejected through the liquid ejection heads 12, provided that the liquid used does not dissolve in the material liquid of the coloring mask 102, and can fix itself to the aluminum material 20. The foregoing configuration can thus appropriately form the coloring mask 102, for example, and appropriately color the aluminum material 20.

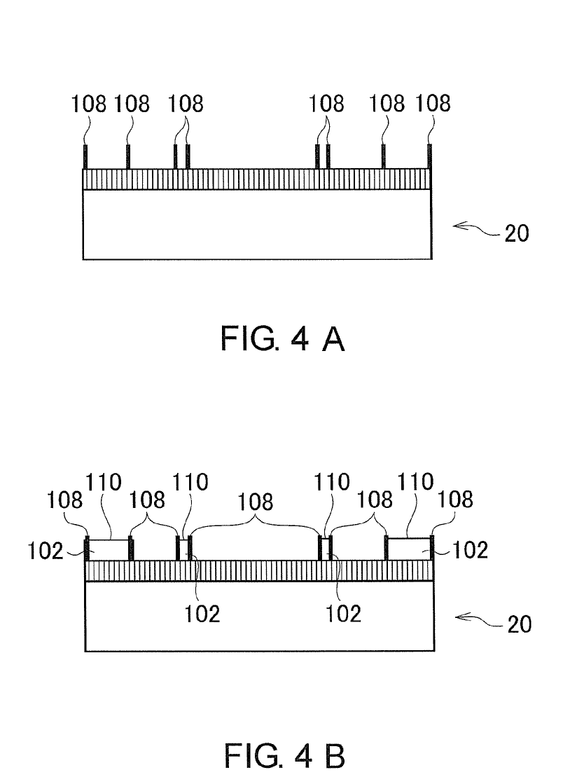

FIGS. 4A˜4B represent a second variation of the coloring mask 102 formation, in which FIGS. 4A and 4B are examples of forming the coloring mask 102 in this variation. The formation of the coloring mask 102 of this variation is the same or similar to that described with reference to FIGS. 1 and 2A˜2C, excepting for the following description. The liquid ejection apparatus 10 used in this variation has the same or similar configuration to that shown in FIG. 2A.

In this variation, a rim forming step and an inner region forming step are performed in the mask forming step. The formation of the coloring mask 102 is thus a two-step process that includes formation of the rim, and formation of the inner region. A rim-forming first mask forming liquid, and an inner region-forming second mask forming liquid are used as the mask forming liquid. The first and second mask forming liquids are ejected through the designated heads in the liquid ejection heads 12 of the liquid ejection apparatus 10.

Specifically, a UV curable ink is used as the first mask forming liquid in this variation. In the rim forming step of the mask forming step S104, a first liquid ejection head 12 is used to eject the first mask forming liquid to a region that becomes the rim of the coloring mask 102, and the first mask forming liquid landed on the aluminum material 20 is irradiated with ultraviolet light with the ultraviolet sources 14 (see FIG. 2). This forms a rim 108 of the coloring mask 102, as shown in FIG. 4A. In this manner, in this variation, only the rim (edge) of the coloring mask 102 pattern is UV cured in the rim forming step.

In the inner region forming step following the rim forming step, a second liquid ejection head 12 is used to eject the second mask forming liquid to the region surrounded by the rim 108 to form an inner region 110 of the coloring mask 102. In the present variation, an ink that requires solvent evaporation for fixing itself to the aluminum material 20 is used as the second mask forming liquid. The ink that requires solvent evaporation for fixing itself to the aluminum material 20 is, for example, an ink that requires removal of the solvent by heat drying or natural drying for fixing itself to the aluminum material 20. For example, a solvent UV ink, or a latex ink may preferably be used as the second mask forming liquid. It is also considered possible to use, for example, an ink containing resin capsules, or a solid ink that is solid at ordinary temperature.

This configuration makes it possible, for example, to sufficiently spread the dots of the second mask forming liquid landed on the aluminum material 20 inside the pattern of the coloring mask 102. The resulting inner pattern can thus have a pore-free homogeneous state. The foregoing configuration can thus more appropriately form the coloring mask 102, for example, in a homogenous fashion with high resolution.

In the rim forming step, it is preferable to irradiate ultraviolet light and cure the first mask forming liquid soon after it has landed on the aluminum material 20. With this configuration, for example, the rim of the coloring mask 102 can be formed at high resolution. This makes it possible to appropriately form the coloring mask 102 of the desired pattern with high accuracy.

The two-step formation of the coloring mask 102 by the rim forming step and the inner region forming step may be performed for, for example, only a region of the coloring mask 102, instead of the whole region. For example, a pattern may be formed with only the first mask forming liquid for a narrow region of the coloring mask 102. For regions that do not require high rim shape accuracy, a pattern may be formed only with the second mask forming liquid. In either case, the coloring mask 102 can be appropriately formed at high resolution in a homogenous fashion by forming different portions of the coloring mask 102 using methods that are suited for different portions.

More than one color may be given to the aluminum material by applications of the methods described with reference to FIGS. 1 to 4B. The following describes an example of such methods of providing more than one color.

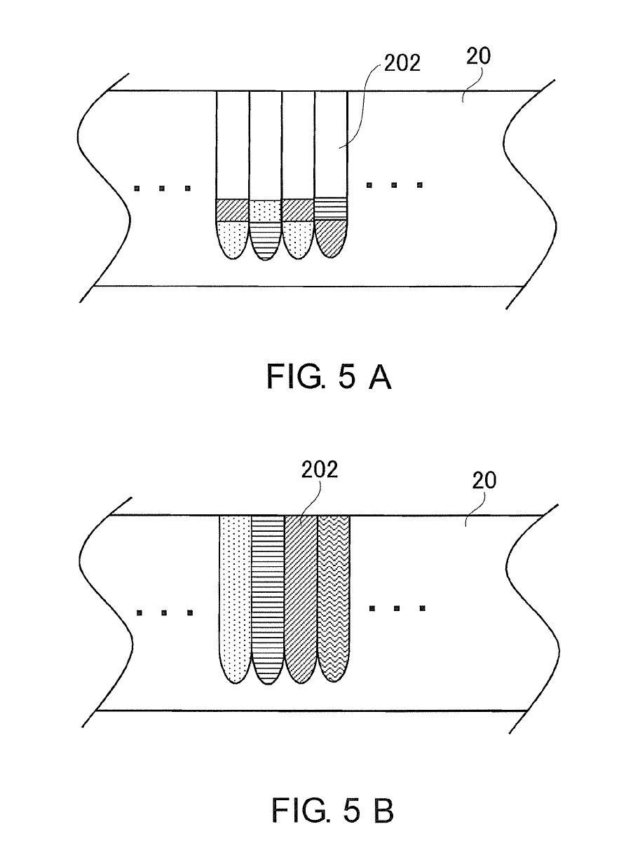

FIGS. 5A˜5B are diagrams representing exemplary methods of coloring the aluminum material 20 in full-color, in which FIG. 5A is a first example of coloring the aluminum material 20 in full-color, and FIG. 5B is a second example of coloring the aluminum material 20 in full-color.

As described in conjunction with FIG. 1, a full-color image can be provided, for example, by repeating the procedures of the mask forming step S104 to the mask detaching step S108 four times with dye inks of YMCK. In this case, for example, the inks of YMCK may be ejected into pores 202 of the alumite coating of the aluminum material 20 with the liquid ejection heads 12 (see FIGS. 2A˜2C) of the liquid ejection apparatus 10 (see FIGS. 2A˜2C) of the configuration shown in FIGS. 2A˜2C.

As a specific example, in this case, more than one color may be charged into a single pore 202 to overlay more than one color in the pore 202, as shown in FIG. 5A. With this configuration, various different colors can be used to realize full-color, for example, by appropriately overlaying inks of different colors YMCK. It is also possible, for example, to place inks of different colors side by side relative to the in-plane direction on the surface of the aluminum material 20 by charging only a single color to each different pore 202, as shown in FIG. 5B. Also in this case, full-color can be realized, for example, in the same manner as in the common printing method employed by inkjet printers. The ink ejected through the liquid ejection heads 12 in this configuration may be a pigment ink.

Aside from the foregoing full-color methods of providing more than one color for the aluminum material 20, a method may be used that provides more than one color using specific colors. For example, two colors may be provided by repeating the procedures of the mask forming step S104 to the mask detaching step S108 of FIG. 1 twice with dye inks of two specific colors, for example, red and black. It is preferable in this case to, for example, define different color regions for the different dye inks in different portions of the aluminum material 20 so that these color regions intended for the different colors do not overlap. With this configuration, for example, two different colors can be more appropriately provided. In certain color applications, for example, the color regions of different colors may be overlaid either partially or completely. In this case, for example, a mesh mask may be used as the coloring mask to provide intermediate colors.

It is also possible to provide multiple (N) colors with greater numbers of dye inks of different colors. As an exemplary configuration, dye inks of different colors (for example, X1, X2) may be used in addition to the dye inks of two different colors, such as red and black. It is also preferable in this case to, for example, define different color regions for the different dye inks in different portions of the aluminum material 20 so that these color regions intended for the different colors do not overlap. With this configuration, for example, N different colors can be more appropriately provided. In certain color applications, for example, the color regions of different colors may be overlaid either partially or completely. In this case, for example, a mesh mask may be used as the coloring mask to provide intermediate colors.

While the embodiments of the present invention have been discussed in the foregoing detailed explanation, the technical scope of the present invention is in no way limited by the description of the embodiments above, and the embodiments may be altered or improved in many ways, as would be obvious to a person of ordinary skill in the art. An embodiment based on such alterations and improvements is encompassed in the technical scope of the present invention, as would be obvious from the appended claims.

### INDUSTRIAL APPLICABILITY

The present invention is suitable for, for example, methods of producing colored aluminum articles.

What is claimed is:

1. A method for masking with an inkjet ink, which is applied to a step of coloring a coloring substrate with a dye solution containing a dye in a solvent, wherein the coloring substrate is colored by permeation of the dye solution, and the method comprising:
a coloring mask forming step of forming a coloring mask which covers a region that is not colored on a surface of the coloring substrate;
a dye coloring step of coloring the coloring substrate with the dye solution in a region not covered by the coloring mask; and
a mask detaching step of detaching the coloring mask from the coloring substrate after the dye coloring step, wherein
in the coloring mask forming step, a mask forming liquid as a liquid for forming the coloring mask is ejected onto the coloring substrate with a liquid ejection head that ejects liquid using an inkjet scheme.

2. The method for masking with an inkjet ink according to claim 1, wherein
the mask forming liquid is a UV curable ink.

3. The method for masking with an inkjet ink according to claim 2, wherein
the mask forming liquid is a UV curable ink having a stretch property after being cured.

4. The method for masking with an inkjet ink according to claim 1, wherein the coloring mask forming step includes:
a rim forming step of forming a rim of the coloring mask with a first mask forming liquid for which a UV curable ink is used; and
an inner region forming step of forming a mask inner region surrounded by the rim of the coloring mask, using a second mask forming liquid for which an ink is used that requires evaporation of solvent for fixing itself to the coloring substrate,
wherein, in the rim forming step, a first liquid ejection head for ejecting the first mask forming liquid is used to eject the first mask forming liquid to a region that becomes the rim of the coloring mask, and the first mask forming liquid landed on the coloring substrate is irradiated with ultraviolet light to form the rim of the coloring mask, and
wherein, in the inner region forming step, a second liquid ejection head for ejecting the second mask forming liquid is used to eject the second mask forming liquid to the region surrounded by the rim formed in the rim forming step, and form the mask inner region of the coloring mask.

5. A coloring system, comprising:
a dye solution, containing a dye in a solvent;
a coloring substrate, being colored by permeation of the dye solution; and
a liquid ejection apparatus, being configured to form a coloring mask that covers a pre-defined region of the coloring substrate, wherein
the liquid ejection apparatus comprises:
a liquid ejection head with which a mask forming liquid as a liquid for forming the coloring mask is ejected using an inkjet scheme; and
a controller, being configured to control the liquid ejection head so as to eject the mask forming liquid to a region of the coloring mask.
